(19) United States
(12) Patent Application Publication
(10) Pub. No.: US 2014/0082680 A1
(43) Pub. Date: Mar. 20, 2014

(54) CONTENT DISTRIBUTION SERVER SYSTEM AND METHOD FOR CONTROLLING THE SAME

(71) Applicant: KABUSHIKI KAISHA TOSHIBA, Minato-ku (JP)

(72) Inventor: Yasumichi HASHI, Tokyo (JP)

(73) Assignee: KABUSHIKI KAISHA TOSHIBA, Minato-ku (JP)

(21) Appl. No.: 13/963,408

(22) Filed: Aug. 9, 2013

(30) Foreign Application Priority Data
Sep. 14, 2012 (JP) 2012-202742

(51) Int. Cl. H04N 21/438

(52) U.S. Cl. CPC H04N 21/438
USPC 725/94

(57) ABSTRACT

According to an embodiment, a content delivery server system is provided with a timer, a buffer, a next transmission time generation part, an abnormality judgment part, and a transmission control part. The buffer holds contents for every session temporarily. The next transmission time generation part generates a next transmission time based on a time stamp added to the contents to be put on an IP packet of next transmission. The abnormality judgment part judges whether a difference between the next transmission time and the present time is greater than a first threshold value which is a positive value, and judges whether the difference is smaller than a second threshold value which is a negative value. The transmission control part performs a control not to transmit the IP packet when the difference between is greater than a first threshold value or is smaller than a second threshold value.

### CROSS-REFERENCE TO RELATED APPLICATION(S)

This application is based upon and claims the benefit of priority from the prior Japanese Patent Application No. 2012-202742, filed on Sep. 14, 2012, the entire contents of which are incorporated herein by reference.

### FIELD

An embodiment of the present invention relates to a content delivery server which provides a VOD (Video On Demand) service to a user for a receiving terminal using an IP (Internet Protocol) network, and a method for controlling the same.

### BACKGROUND

In recent years, fusion of “broadcast” and “communication” progresses increasingly as a communication network becomes high-speed and highly efficient, and a demand of VOD service is expected. This VOD service delivers contents, such as movie and music, using an IP network. According to the VOD service, people always anywhere can enjoy various contents such as movie, music etc. using not only a video display device of his/her house but a smartphone or a tablet device without going to a movie theater, a video rental shop etc.

It may become impossible suddenly for a viewer to view the contents during viewing of the contents by the VOD service. As for a factor that viewing of the contents becomes impossible suddenly, it is thought that contents-viewing demands from a plurality of users gather on the same time zone.

A purpose of the present invention is to provide a content delivery server system which can address effectively an abnormality of a contents failure by some factors and an abnormality occurs when the contents-viewing demands gather on the same time zone, and a method for controlling the same.

### BRIEF DESCRIPTION OF THE DRAWINGS

FIG. 1 is a block diagram showing a content delivery system concerning an embodiment;

FIG. 2 is a functional block diagram of a delivery controller concerning the embodiment;

FIG. 3 is a drawing showing a relation of TTS (Timestamped Transport Stream)s of MPEG and a RTP packet;

FIG. 4 is a diagram showing a transmission timing of the RTP packet;

FIG. 5 is a flow chart which shows a procedure and contents of an abnormality judgment and abnormality correspondence control by a delivery controller concerning the embodiment;

FIG. 6 is a diagram showing a transmission timing showing an example of a transmission time abnormality in the embodiment; and

FIG. 7 is a diagram showing a transmission timing which shows a situation when a next transmission time becomes the past prior to the present time in the embodiment.

### DETAILED DESCRIPTION

According to an embodiment, a content delivery server system puts a contents demanded on a plurality of IP packets according to a contents-viewing demand from a terminal device on an IP (Internet Protocol) network, and sends the contents demanded to the IP network per an IP packet. The content delivery server system is provided with a timer, a buffer, a next transmission time generation part, an abnormality judgment part, and a transmission control part. The timer clocks a present time. The buffer holds the contents for every session temporarily when the contents-viewing demand comes from the terminal device. Based on a time stamp added to a contents put on an IP packet of next transmission, the next transmission time generation part generates a next transmission time of the IP packet. The abnormality judgment part calculates a difference between the next transmission time generated by the next transmission time generation part and the present time clocked by the timer, judges whether the difference is greater than a first threshold value which is positive value, and judges whether the difference is smaller than a second threshold value which is negative value. The transmission control part performs a control for executing a transmission processing of the IP packet when the difference between the next transmission time and the present time is not smaller than the second threshold value and is not greater than the first threshold value, and does performs a control for not executing the transmission processing of the IP packet when the difference between the next transmission time and the present time is greater than the first threshold value or less than the second threshold value.

Hereinafter, an embodiment will be described with reference to drawings.

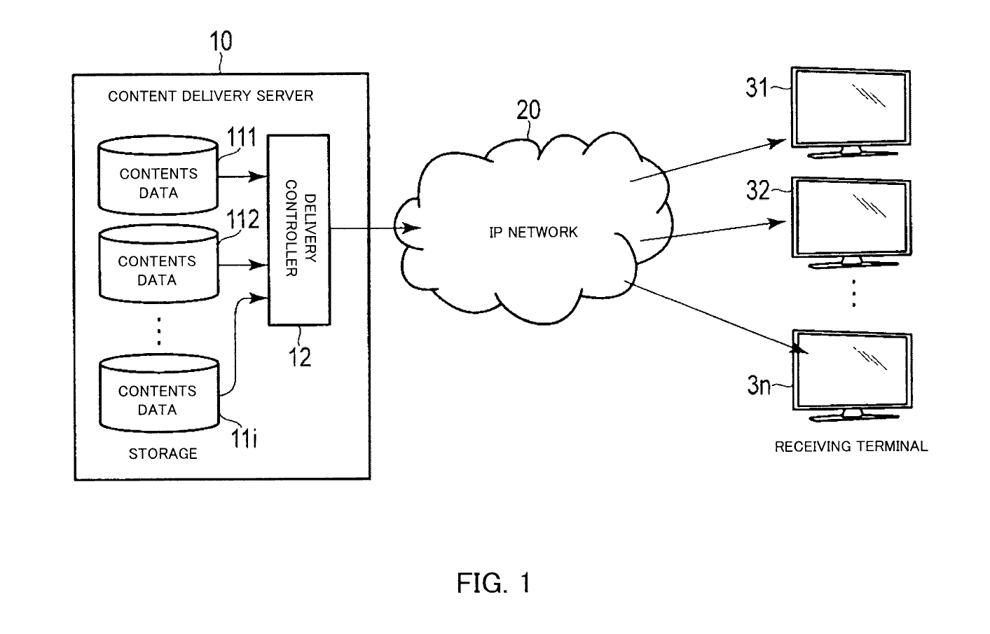

FIG. 1 is a block diagram showing a content delivery system concerning one embodiment. The system shown in FIG. 1 comprises a video delivery server 10 and receiving terminals 31-3n (n is an integer) connected with the video delivery server 10 via an IP network 20. The video delivery server 10 performs as a content delivery server system and the receiving terminals 31-3n function as terminal devices.

The video delivery server 10 is provided with storage parts 111-11i (i is an integer) which store data of a plurality of contents, and a delivery controller 12. Contents data for VOD from a master storage which is not shown in FIG. 1, and contents information, control information, etc. which are needed at a time of content delivery, are cached in the storage parts 111-11i. The contents data for VOD is stored in a TTS (Timestamped TS) format in which time stamp information is added to head 4 bytes of TS (Transport Stream) data of 188 bytes. A time stamp of 4 bytes is generated by counting a 27 MHz clock signal, and expresses a transmission time or a time lag to a transmission time of a precedence packet.

In the video delivery server 10, the delivery controller 12 receives a contents viewing demand from the receiving terminals 31-3n via the IP network 20. Then, the delivery controller 12 reads the TTSs which constitute a contents data demanded from the storage parts 111-11i based on the contents viewing demand, and puts, for example, seven TTSs on a RTP (Real-time Transport Protocol) packet used as one IP packet, and sends the RTP packet, that is the contents, to the receiving terminal 31 of a requestor via the IP network 20.

On the other hand, the receiving terminal 31 receives the RTP packet sent from the video delivery server 10 via the IP network 20, reproduces the TTS from the RTP packet by executing various communications protocol processing, takes out picture image data from the TTS, decodes the picture image data and presents the contents in an image and sound form.

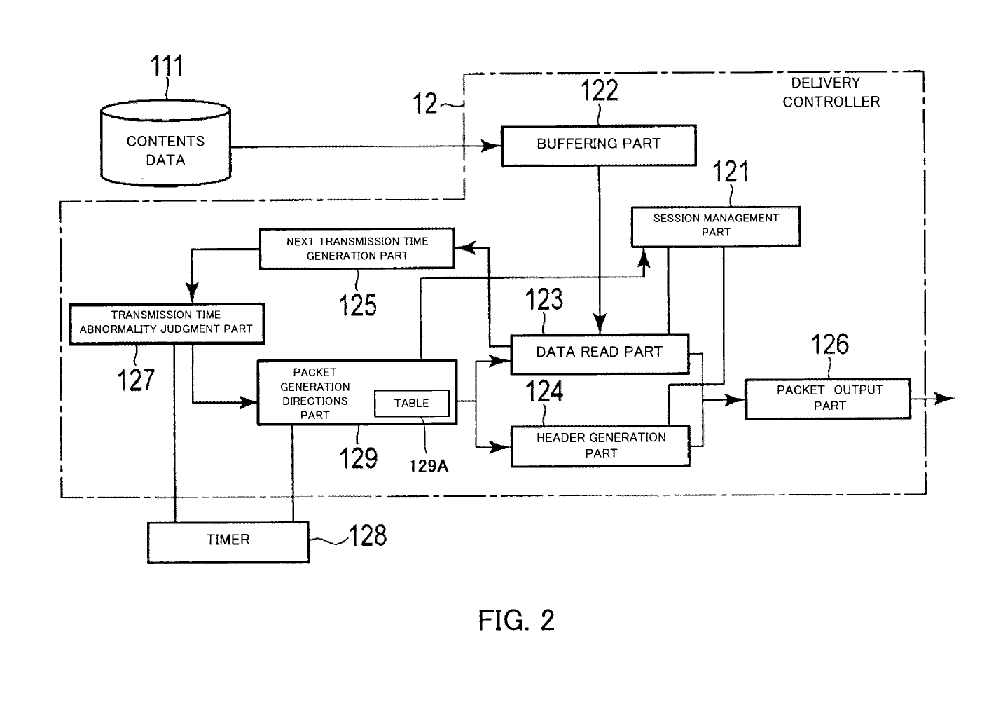

FIG. 2 is a functional block diagram of the delivery controller 12. The delivery controller 12 has a session management part 121, a buffering part 122, a data read part 123, a header generation part 124, a next transmission time generation part 125, the packet output part 126, a transmission time abnormality judgment part 127, and the packet generation direction part 129. The video delivery server 10 has a timer 128 in an outside of the delivery controller 12. The transmission time abnormality judgment part 127, the buffering part 122, and the packet generation direction part 129 correspond to an abnormality judgment part, a buffer, and a transmission control part which are indicated to in claims, respectively. In the delivery controller 12, when the packet generation direction part 129 receives a contents viewing demand from the receiving terminal 31, the packet generation direction part 129 issues a packet generation direction to the session management part 121. The session management part 121 reads delivery control information on a session concerned. The buffering part 122 reads a required number of TTSs for transmission processing from the storage part 111, and buffers the TTSs temporary.

Based on the delivery control information from the session management part 121, the data read part 123 reads the TTSs from the buffering part 122, and transfers the TTSs of the specified number of packets to a packet output part 126 as RTP payload data of a RTP packet. At this time, the data read part 123 also reads a time stamp portion of the TTS which should be transmitted next time, and notifies the time stamp information of TTS which should be transmitted next time to a next transmission time generation part 125.

The header generation part 124 performs a calculation of contents of a RTP header, an UDP (User Datagram Protocol) header, and an IP header which should be sent out, based on the delivery control information from the session management part 121, and writes the contents of the header of the RTP packet in a memory (not shown in FIG. 2) of the packet output part 126.

Based on the time stamp of TTS which should be transmitted next time, the next transmission time generation part 125 generates a next transmission time of the RTP packet of this session, and outputs information on the next transmission time to the transmission time abnormality judgment part 127. At the time of transmission of the RTP packet, the transmission time abnormality judgment part 127 calculates a difference between the next transmission time and the present time clocked by the timer 128. In addition, the transmission time abnormality judgment part 127 judges whether the difference is greater than a positive threshold value α set up beforehand, and judges whether the difference is smaller than a negative threshold value −α set up beforehand, and outputs a decision result to the packet generation direction part 129. In addition, the transmission time abnormality judgment part 127 also outputs the next transmission time to the packet generation part 129.

In a case where the decision result shows that the difference between the next transmission time and the present time is greater the threshold value α or is smaller than the threshold value −α, that is, the next transmission time is abnormal, the packet generation direction part 129 does not register the next transmission time and thereby stops a transmission of a next abnormal RTP packet. In a case where the decision result shows that the difference is not smaller than the threshold value −α and is not greater than the threshold value α, the packet generation direction part 129 registers the next transmission time of this session into a transmission time table 129A in the packet generation direction part 129. When an internal time which the timer 128 clocks reaches the next transmission time registered, the packet generation direction part 126 issues a packet generation direction of the session to the session management part 121, and makes the data read part 123 and the header generation part 124 perform their processing, respectively.

The packet output part 126 stores the header of the RTP packet from the header generation part 124 and the payload data of the RTP packet transferred from the data read part 123, and thereby generates the RTP packet, and sends the RTP packet to the IP network 20 properly. Notes that, above-mentioned each part is constituted by a program and a processor operated by the program.

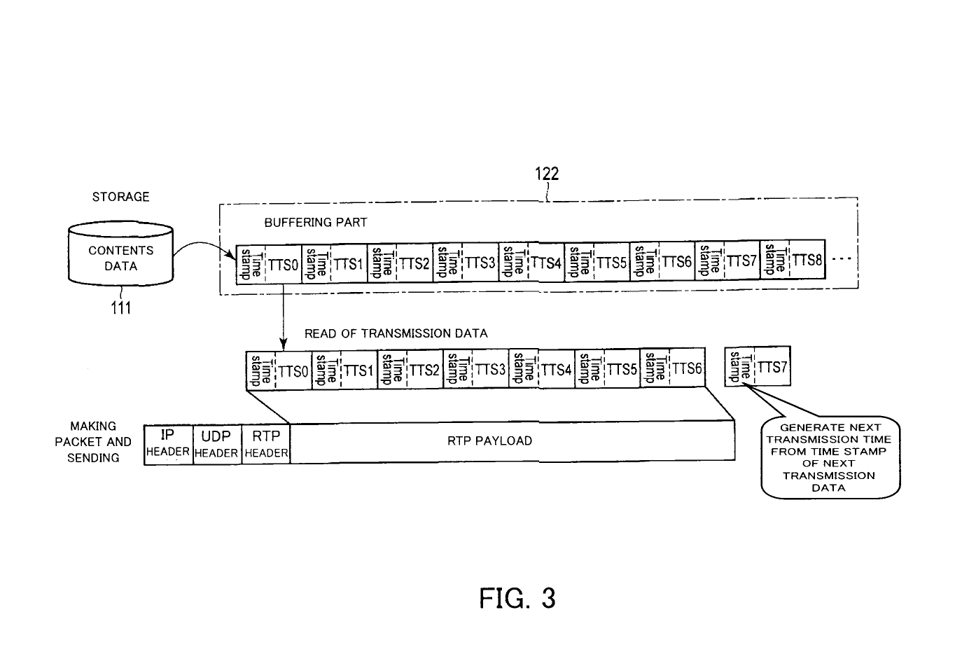

Next, an operation in the above-mentioned composition will be explained. FIG. 3 shows a relation of the TTS of MPEG (Moving Picture Experts Group) standard which constitutes the contents data and the RTP packet. In the delivery controller 12, the TTS which is read from the storage part 111 is accumulated in the buffering part 122 one by one. The TTS is constituted by a 4-byte time stamp, a 4-byte fixed length TS header which begins from a start code of a fixed pattern called a synchronous byte (0x47), and a 184-byte payload.

The RTP packet has a header and a RTP payload. The header of the RTP packet includes an IP header, a UDP header and an RTP header. The TTSs up to seven pieces are packed up in one RTP payload.

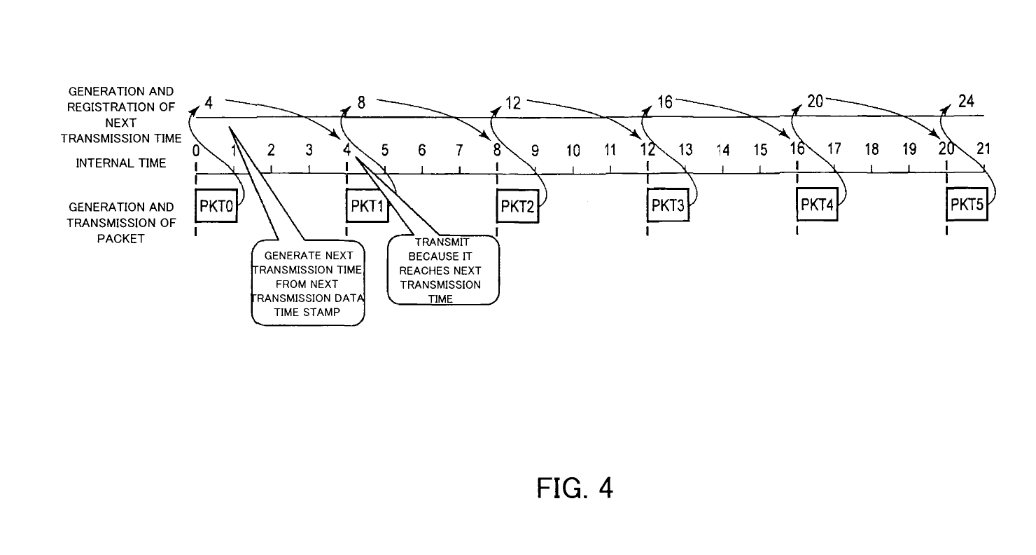

FIG. 4 shows a timing of transmission of the RTP packet. The video delivery server 10 manages a transmission interval of contents data according to a time stamp of TTS of MPEG, and sends the contents data.

In the video delivery server 10, when a transmission direction from the packet generation direction part 129 is received, the data read part 123 reads the TTSs of the contents data of a session concerned which is buffered in the buffering part 122, and the packet output part 126 generates and outputs one RTP packet in which seven TTSs are packed. At that time, the data read part 123 also reads a time stamp portion of a TTS packet of MPEG of the session concerned which will be transmitted after the packet of the session which is transmitted this time. The next transmission time generation part 125 generates a next transmission time from the time stamp of TTS of MPEG which will be transmitted next time, and the transmission time abnormality judgment part 127 judges whether the next transmission time is proper. In a case where a decision result of the transmission time abnormality judgment part 127 shows that the next transmission time is not abnormal, the next transmission time is registered to the packet generation direction part 129. When the internal time which the timer 128 clocks reaches the next transmission time which is registered, the data read part 123 reads the data of this session which should be transmitted, and the packet output part 126 generates one RTP packet in which seven TTSs are packed and sends the RTP packet. In addition, the next transmission time generation part 125 generates a next transmission time. This processing is repeated and transmission of the packet is continued. In transmission of a plurality of sessions, according to a transmission interval for every contents transmitted in each session, the processing which reads a data, transmits the data and generates a next transmission time is performed in an order which the present time reaches a transmission time of each session.

Here, since the next transmission time is created based on the time stamp of TTS of MPEG, when data buffered in the buffering part 122 which is abnormal by a certain factor, a next transmission time is generated based on an incorrect time stamp. For this reason, a transmission time whose transmission interval is incorrect will be generated, and a transmission time of a packet which will be transmitted next time will be greatly separated from the right transmission time. If a transmission time deviates from an original transmission interval greatly, a receiver end cannot receive the contents data correctly, and reproduction of the contents data is influenced. If a contents data itself is broken, it is impossible to reproduce the contents data even if the contents data is received, and therefore it is worthless to transmit the contents data.

When it is judged that a difference between a next transmission time generated and the internal present time greatly differs from a usual transmission interval of one RTP packet when the next transmission time is generated, it can be detected whether the next transmission time generated has any problem. If the receiver end can not reproduce the contents data transmitted, the packet generation direction part can take a measure to stop the transmission of contents data etc based on the decision result.

Usually, the next transmission time becomes a future time to the present time. For this reason, if it is judged that the difference between the next transmission time and the present time is separated greatly from a usual one RTP packet transmission interval by some extent, a transmission time abnormality by contents data breakdown can be detected. However, since transmission processing and generation of next transmission time for a plurality of sessions are performed in order when the plurality of sessions become a transmission time simultaneously, the transmission processing will be started in time which deviated from original transmission time gradually. If overlaps of transmission times of the plurality of sessions continue, original transmission time has passed when a turn of transmission processing has come. For this reason, if data is read at that time, a packet is generated, the packet is outputted and a next transmission time is generated, it may occur that the next transmission time is the past time to the present time.

However, in transmission of MPEG etc., it may be permissible that there are a time when a bit rate per unit time is dense and a time when a bit rate per unit time is coarse. Since a receiving side is not necessarily immediately affected by influence just because a larger interval time than a transmission interval of one RTP packet is generated, this should not be judged to be abnormal.

Accordingly, in this embodiment, the transmission time abnormality judgment part 127 performs a transmission time abnormality detection judgment which detects the transmission time abnormality by a contents breakdown by a certain factor and which does not detect the coarse and dense of the packet transmission interval as abnormal.

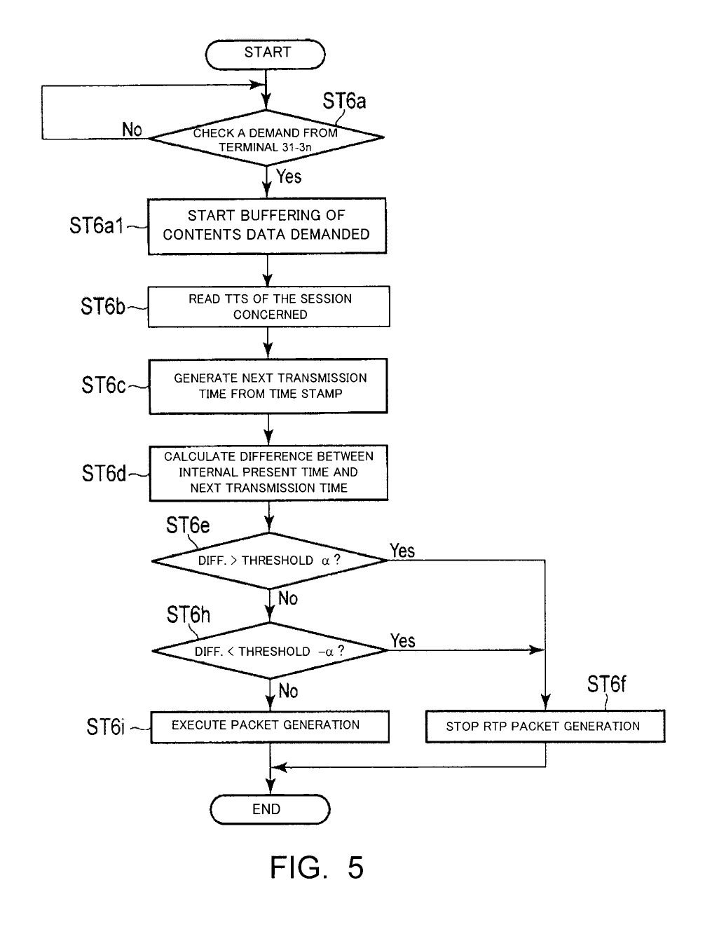

FIG. 5 is a flow chart which shows a procedure and contents of an abnormality judgment and abnormality correspondence control by the delivery controller 12.

The packet generation direction part 129 of the delivery controller 12 monitors whether a contents viewing demand from users of receiving terminals 31-3n comes (step ST6a.) When the contents viewing demand comes (Yes at step ST6a,) the delivery controller 12 reads the TTSs which constitute the contents data demanded from the storage part 111 which stores the contents data and buffers them in the buffering part 122 (step ST6a1,) the data read part 123 reads the TTSs buffered from the buffering part 122 (step ST6b,) the header generation part 124 generates a header, and the packet output part 126 generates an packet and outputs it. And, the next transmission time generation part 125 generates a next transmission time from a time stamp of the next transmission TTS (step ST6c.) When the present time which the timer 128 clocks reaches the next transmission time, based on a next packet generation direction, the data read part 123 reads the TTSs buffered, the header generation part 124 generate the header, and the packet output part 126 generates the packet and outputs it.

The transmission time abnormality judgment part 127 of the delivery controller 12 performs a transmission time abnormality judgment after generating the next transmission time. That is, the transmission time abnormality judgment part 127 calculates a difference between the next transmission time and the present time which the timer 128 clocks (step ST6d,) and judges whether a formula 1 is satisfied (step ST6e.)

Next transmission time−Internal present time>α α: Threshold value Formula 1:

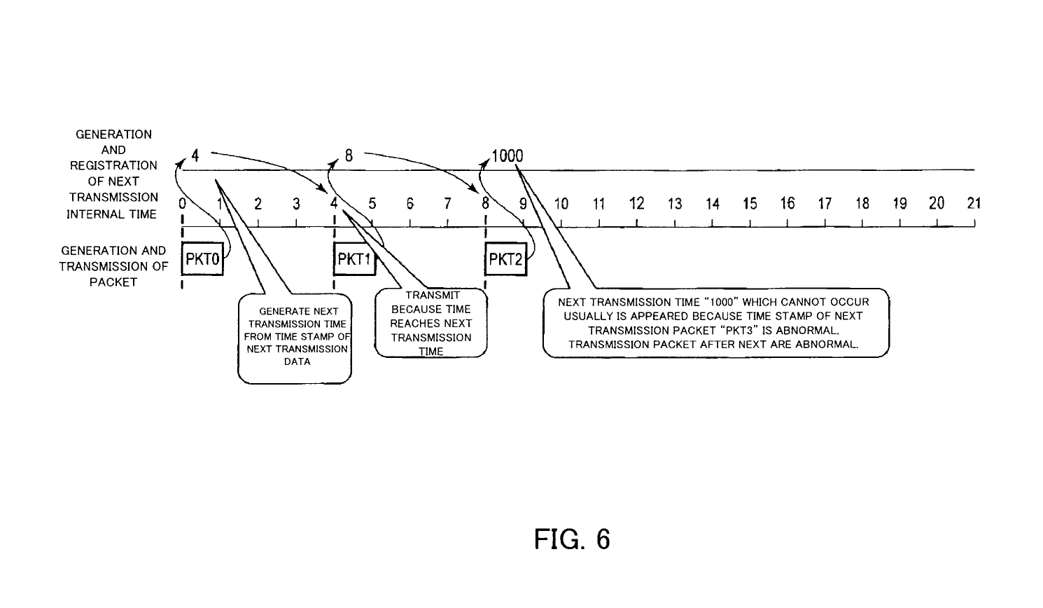

Here, FIG. 6 shows an example which a transmission time becomes abnormal. In this example, the threshold value α is temporarily set to “100” as a value which cannot usually happen. When a next transmission time is generated as “1000” because of the abnormality of the time stamp of TTS “PKT3,” a difference is set to “1000−8=992.” Therefore, the difference exceeds “100” set as the threshold value α (Yes in step ST6e,) and the transmission time abnormality judgment part 127 can detect a transmission time abnormality.

The delivery controller 12 stops generation processing of a RTP packet (step ST6f).

On the other hand, when the difference between the next transmission time and the present time which the timer 128 clocks is not greater than the threshold value α (No in step ST6e,) the transmission time abnormality judgment part 127 judge whether the difference between the next transmission time and the present time which the timer 128 clocks is smaller than threshold value −α (step ST6h.)

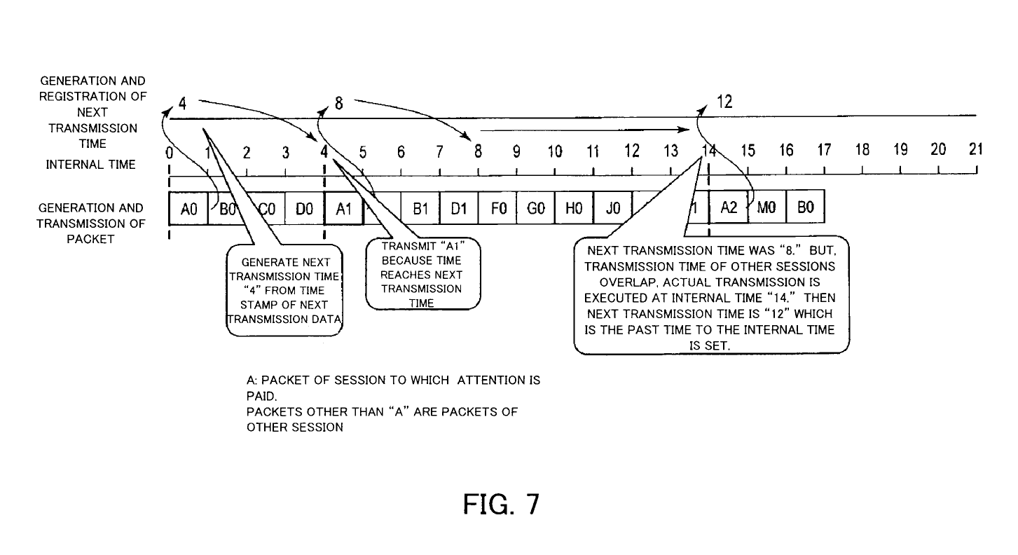

Here, as shown in FIG. 7, when the next transmission time becomes the past to the present time at the time of simultaneous play in large numbers, by the formula 1, it is set to 12−14=−2 and thereby the left side becomes a value of minus. The time stamp added to the TTS is a counted value of a 32-bit without sign where a 27 MHz clock signal is counted up in a forward direction. The next transmission time and the internal present time are also 32-bit values without sign bit. In a value of minus, “1” stands on the most significant bit, and a value becomes 4,294,967,294 and is a value larger than the threshold value “100” of the formula 1, and thereby the transmission time abnormality is detected.

However, since the coarse time and dense time may be permissible even if there are coarse time and dense time at the bit rate per unit time in transmission of MPEG etc., the delivery controller 12 detect that a case of FIG. 7 is not abnormal.

Accordingly, the delivery controller 12 judges whether the difference between the next transmission time and the present time which the timer 128 clocks fulfills a formula 2.

−α<the next transmission time−the internal present time<α Formula 2:

Thus, values are set to a maximum threshold value α and a minimum threshold value −α, respectively, and the difference between both threshold values is permitted. According to this, the case of FIG. 7 is not erroneously detected as abnormal.

Here, in a case where the difference between the next transmission time and the present time which the timer 128 clocks fulfills the formula 2 (No in step ST6e and No in step ST6h,) the delivery controller 12 performs generation processing of RTP packet (step ST6i.)

On the other hand, in a case where the difference between the next transmission time and the present time which the timer 128 clocks is smaller than −α (Yes in step ST6h,) the delivery controller 12 judges that an abnormality occurred in the buffering part 122 and shifts the processing to the step ST6f.

A value of α is set up for every system and values, such as 500 ms and 1 sec, etc. are set up as the α in fact. In addition, the value of a may be changed for every system to be used. In a case that as for a system in which many users view the contents a large value is set for the α and as for a system in which small number of users view the contents a small value is set as the α, optimal abnormality detection can be performed according to an use environment etc.

As mentioned above, the next transmission time generation part 125 of the delivery controller 12 generates a next transmission time when a next RTP packet is transmitted to the IP network 20 using a time stamp added to TTS stored in the buffering part 122 temporarily. The delivery controller 12 has the threshold value α for detecting the abnormality of a contents breakdown and the threshold value −α for detecting the abnormality which occurs when a plurality of contents viewing demands concentrate on the same time zone. The transmission time abnormality judgment part 127 of the delivery controller 12 calculates the difference between the next transmission time generated and the present time clocked by the timer 128. When the difference exceeds the threshold value α, the transmission time abnormality judgment part 127 judges that next transmission time is abnormal by a contents breakdown by a certain factor. When the difference becomes in smaller than threshold value −α, the transmission time abnormality judgment part 127 judges that there is an abnormality in which the next transmission time, which is produced when the contents viewing demands by a plurality of sessions concentrate on the same time zone, is separated from the present time greatly to the past time

Therefore, the content delivery system according to the embodiment can detect the abnormality of the transmission time by the contents breakdown by a certain factor and the abnormality in which the next transmission time, which is produced when contents viewing demands by a plurality of sessions concentrate on the same time zone, is separated from the present time greatly to the past, that is, only the abnormality which can not be relieved by each of receiving terminals 31-3n, and does not detect the coarse and dense of the packet transmission interval as abnormal. Therefore, according to the content delivery server system and a method for controlling the same of the present invention, an efficient transmission of the RTP packet is realizable.

The above-mentioned embodiment explains the case where the number of TTSs packed up by one RTP packet is seven, however, the number of TTSs packed up by one RTP packet may be except seven. The contents data may be the contents data other than TTS of MPEG.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content delivery server system which puts contents demanded on a plurality of IP packets according to a contents viewing demand from a terminal device on an IP (Internet Protocol) network, and sends the contents demanded to the IP network per the IP packet, the content delivery server system comprising:
a timer which clocks the present time;
a buffer which holds the contents for a session temporarily when the contents viewing demand comes from the terminal device;
a next transmission time generation part which generates a next transmission time of an IP packet based on a time stamp to be added to a contents put on the IP packet of next transmission;
an abnormality judgment part which calculates a difference between the next transmission time generated by the next transmission time generation part and the present time clocked by the timer, judges whether the difference is greater than a first threshold value which is positive value, and judges whether the difference is smaller than a second threshold value which is negative value; and
a transmission control part
which performs a control for executing a transmission processing of the IP packet when the difference between the next transmission time and the present time is not smaller than the second threshold value and is not grater than the first threshold value, and
which performs a control for not executing the transmission processing of the IP packet when the difference between the next transmission time and the present time is greater than the first threshold value or is smaller than the second threshold value.

2. The content delivery server system according to claim 1, wherein
the buffer holds a TTS (TimestampedTransport Stream) packet of MPEG (Moving Picture Expert Group) standard of the contents for the session temporarily when the contents viewing demand comes from the terminal device, and
the next transmission time generation part generates the next transmission time based on the time stamp added to the TTS packet which is put on the IP packet of next transmission.

3. The content delivery server system according to claim 1, wherein one of the first threshold value and the second threshold value is variable for the system.

4. The content delivery server according to claim 1, wherein the buffer holds a plurality of the contents for every sessions temporarily when a plurality of contents viewing demands come from the terminal devices.

5. The content delivery server system according to claim 1, wherein the transmission control part has a transmission time table,
in a case that the difference between the next transmission time and the present time is not smaller than the second threshold value and is not greater than the first threshold value, the transmission control part registers the next transmission time in the transmission time table, and performs a control for executing a transmission processing of the IP packet when the present time reaches the next transmission time registered in the transmission time table, and
in a case that the difference between the next transmission time and the present time is greater than the first threshold value or is smaller than the second threshold value, the transmission control part performs a control for not executing a transmission processing by not registering the next transmission time in the transmission time table.

6. A control method used for a content delivery server system which puts a contents demanded on a plurality of IP packets in a delivery control part and sends the contents demanded to an IP network per the IP packet according to a contents viewing demand from a terminal device on the IP (Internet Protocol) network, the control method comprising:
clocking a present time by a timer;
holding the contents to a buffer for a session temporarily when the contents viewing demand comes from the terminal device;
generating a next transmission time of an IP packet based on a time stamp added to the contents to be put on the IP packet of next transmission;
calculating a difference between the next transmission time and the present time which is clocked by the timer, judging whether the difference is greater than a first threshold value of positive value, and judging whether the difference is smaller than a second threshold value of negative value;
performing a control for executing a transmission of the IP packet when a difference between the next transmission time and the present time is not smaller than the second threshold value and is smaller than the first threshold value, and
performing a control for stopping a transmission of the IP packet when the difference between the next transmission time and the present time is greater than the first threshold vale or is smaller than the second threshold value.
